(19) United States
(12) Patent Application Publication
(10) Pub. No.: US 2023/0401497 A1
(43) Pub. Date: Dec. 14, 2023

(54) EVENT RECOMMENDATIONS USING MACHINE LEARNING

(71) Applicant: VMWARE, INC., Palo Alto, CA (US)

(72) Inventors: RAVISH CHAWLA, Atlanta, GA (US); Rohit Pradeep Shetty, Bangalore (IN); Adam Chow, Atlanta, GA (US)

(21) Appl. No.: 17/886,492

(22) Filed: Aug. 12, 2022

(30) Foreign Application Priority Data
Jun. 9, 2022 (IN) 202241033046

(51) Int. Cl. G06Q 10/06; G06N 20/00

(52) U.S. Cl. CPC G06Q 10/06311; G06N 20/00

(57) ABSTRACT

Disclosed herein are examples of systems and methods for recommending events using machine learning. A first recommendation can be generated based at least in part on at least one user parameter associated with a user. The first recommendation can comprise a first event. The first recommendation can be provided to a client device associated with the user, and a user response to the recommendation can be received from the client device. A second recommendation can be generated based at least in part on the user response and the at least one user parameter, wherein the second recommendation comprises a second event. The second recommendation can be provided to the client device.

### RELATED APPLICATIONS

Benefit is claimed under 35 U.S.C. 119(a)-(d) to Foreign Application Serial No. 202241033046 filed in India entitled “EVENT RECOMMENDATIONS USING MACHINE LEARNING”, on Jun. 9, 2022, by VMware, Inc., which is herein incorporated in its entirety by reference for all purposes.

### BACKGROUND

With users operating remotely more and more, practical situations that are taken for granted in an in-person environment need to be replicated in an online environment. In in-person environments, users within an organization can organize events like, for example, webinars, conference calls, office hours, social calls, team meetings, and technology or subject matter talks that are open to other employees. For users operating remotely, however, it may be difficult to stay informed of such events. Because emails and direct messaging platforms are often the primary means of communicating information regarding events, it may be difficult to advertise these events beyond established mailing lists or outside of groups within an organization. Thus, users who are not members of particular lists or groups may never learn about events that may be relevant to those users. This is particularly true for users operating remotely, since they may be less likely to interact with administrators who could add them to those lists.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 shows an example of a network environment, according to various embodiments of the present disclosure.

FIG. 2 shows a sequence diagram that provides one example of functionality implemented by components of the networked environment, according to various embodiments of the present disclosure.

FIG. 3 shows a flowchart that provides one example of the operation of a portion of a recommendation application executed in the network environment of FIG. 1, according to various embodiments of the present disclosure.

### DETAILED DESCRIPTION

Disclosed are various approaches for generating event recommendations using machine learning. Events such as webinars, audio- or video-conferences, or other events might be announced within an organization using only email or a direct messaging platform. Thus, it may be difficult to invite users to promulgate event invitations outside of established mailing lists and inform users within an organization of upcoming events. To that end, the disclosed approaches provide a platform that allows users to discover events that they may wish to attend. The disclosed approaches employ machine learning to curate topics and allow a user to discover and stay informed of events.

The disclosed platform can recommend upcoming events such as webinars and conference calls, as well as recordings of previous events, including both in-person events, virtual events, and hybrid in-person and virtual events. An event may be tagged with one or more keywords or keyphrases that can be generated based on the content of the event. In some implementations, users can elect to be alerted of events with particular tags.

In some implementations, the disclosed platform can be integrated with other applications. For example, the disclosed platform can be displayed in other applications where users may go to explore new applications, people, and other interests related to their organization and professional development. As another example, the disclosed platform can be integrated with a user's calendar to automatically suggest events that the user may be interested in at times when the user is available.

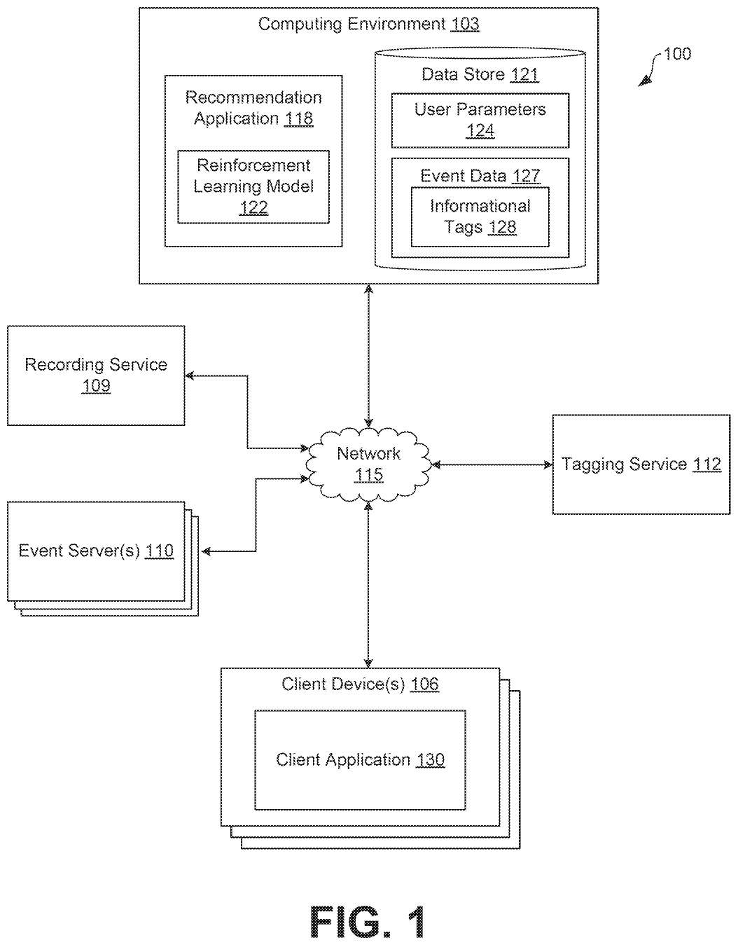

FIG. 1 shows an example of a networked environment 100 according to various embodiments. The networked environment 100 can include a computing environment 103, one or more client devices 106, a recording service 109, one or more event servers 110, and a tagging service 112 in communication through a network 115.

The network 115 can include the Internet, intranets, extranets, wide area networks (WANs), local area networks (LANs), wired networks, wireless networks, other suitable networks, or any combination of two or more such networks. The networks can include satellite networks, cable networks, Ethernet networks, telephony networks, and other types of networks. The network 115 can include wide area networks (WANs) and local area networks (LANs). These networks can include wired or wireless components or a combination thereof. Wired networks can include Ethernet networks, cable networks, fiber optic networks, and telephone networks, such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (e.g., WI-FIC)), BLUETOOTH® networks, microwave transmission networks, as well as other networks relying on radio broadcasts. The network 115 can also include a combination of two or more networks 115. Examples of networks 115 can include the Internet, intranets, extranets, virtual private networks (VPNs), and similar networks.

The computing environment 103 can be embodied as one or more computers, computing devices, or computing systems. In certain embodiments, the computing environment 103 can include one or more computing devices arranged, for example, in one or more servers or computer banks. The computing device or devices can be located at a single installation site or distributed among different geographical locations. The computing environment 103 can include a plurality of computing devices that together embody a hosted computing resource, a grid computing resource, or other distributed computing arrangement. In some cases, the computing environment 103 can be embodied as an elastic computing resource where an allotted capacity of processing, network, storage, or other computing-related resources vary over time. As further described below, the computing environment 103 can also be embodied, in part, as certain functional or logical (e.g., computer-readable instruction) elements or modules as described herein.

The computing environment 103 can operate as an environment for mobile device management or a Unified Endpoint Management (UEM) platform that can manage the client devices 106. In that context, the computing environment 103 can execute a recommendation application 118 and potentially other application(s). The computing environment 103 can also include a data store 121.

The data store 121 can include memory of the computing environment 103, mass storage resources of the computing environment 103, or any other storage resources on which data can be stored by the computing environment 103. The data store 121 can include one or more databases, such as a structured query language (SQL) database, a non-SQL database, or other appropriate database. The data stored in the data store 121, for example, can be associated with the operation of the various applications or functional entities described below. The data store 121 can include user parameters 124, event data 127, informational tags 128, and potentially other types of data.

The recommendation application 118 can be executed to recommend events to a user of the client device 106. The recommendation application 118 can generate a recommendation for a user based on various user parameters 124 corresponding to a user and informational tags 128 corresponding to various events from the event data 127. The recommendation application 118 can use the user parameters 124 to determine what kinds of events the user may be interested in. The recommendation application 118 can determine whether to recommend an event based on any informational tags 128 stored in association with the event in the event data 127. Thus, the recommendation application 118 can generate a recommendation for a user based on how different events' informational tags 128 relate to the user's user parameters 124.

The recommendation application 118 can generate event recommendations for a user using a reinforcement learning model 122. The reinforcement learning model 122 can be, for example, a reinforcement learning algorithm or other machine learning approach. In some implementations, the reinforcement learning model 122 can be initialized with randomized recommendations for each user, thereby allowing the reinforcement learning model 122 to vary its recommendations between users.

In some implementations, the recommendation application 118 can generate recommendations based on a user subscribing to one or more specific informational tags 128. When the client application 130 indicates to the recommendation application 118 that a user has subscribed to an informational tag 128, the recommendation application 118 can thereafter recommend any event from the event data 127 having a matching informational tag 128. In some implementations, the recommendation application 118 can refrain from recommending an event an event with a subscribed-to informational tag 128 if the user's user parameters 124 indicate, for example, that the event conflicts with a date and time restriction of the user.

The reinforcement learning model 122 can be trained based on a user accepting or declining event recommendations to learn the user's preferences. For example, when a user accepts a recommendation, the reinforcement learning model 122 may be more likely to recommend future events with informational tags 128 that are similar to the informational tags 128 stored in association with the event in the event data 127. As another example, when a user declines a recommendation, the reinforcement learning model 122 may be less likely to recommend future events with informational tags 128 that are similar to the informational tags 128 stored in association with the event in the event data 127. As an additional example, if a user accepts (or declines) a recommendation for one session of a recurring event, the reinforcement learning model may be more (or less) likely to recommend future instances of that recurring event.

The user parameters 124 can represent information about the user that is relevant to what events the user may or may not wish to attend. The user parameters 124 corresponding to a user can therefore be used when generating a recommendation for that user. The user parameters 124 can include, for example, organizational role, organizational unit, location, schedule, user interest, and other parameters.

The organizational role user parameter 124 can represent a role performed by a user within an organization. Events can vary in relevance based on a user's organizational role. Thus, the recommendation application 118 may be more likely to recommend an event an event if a user's organizational role user parameter 124 is relevant to the subject matter of the event and the associated informational tags 128. Information for the organizational role user parameter 124 can in some implementations be obtained from the client application 130.

The organizational unit user parameter 124 can represent a user's association with a particular business unit, division, or subgroup within an organization. An organization can have various units that each deals with a different focus area or performs a different function within the organization. Some events may include information tags 128 that are more relevant to an organizational unit's focus area and thus more relevant to user associated with that organizational unit. The recommendation application 118 can therefore account for a user's organizational unit user parameter 124 when generating event recommendations for that employee. Information for the organizational unit user parameter 124 can in some implementations be obtained from the client application 130.

The location user parameter 124 can represent a user's location or a location of facility or site with which the user is affiliated. Events may be specific to a particular location. Such events may therefore be more relevant to users affiliated that particular location. Thus, the recommendation application 118 can consider a user's location when recommending events. Information for the location user parameter 124 can in some implementations be obtained from the client application 130.

The schedule user parameter 124 can represent a user's schedule, including any meetings, event, or other periods during which a user is unavailable and, conversely, periods during which the user is available. The recommendation application 118 can use a user's periods of availability as a factor when recommending an event. For events that recur periodically, the recommendation application 118 may also be more likely to recommend future instances of an event that a user has attended. Information for the schedule user parameter 124 can in some implementations be obtained from the client application 130.

The user interest user parameter 124 can represent topics or categories of events that a user may be interested in. The recommendation application 118 may be more likely to recommend an event if conforms to the user's interests. That is, if a particular event is associated with informational tags 128 that match a user's user interest user parameter(s) 124, the recommendation application 118 may be more likely to recommend the event.

The user interest user parameter 124 can include, for example, results of a questionnaire given to the user by the client application 130. As another example, the user interest user parameter 124 can include information mined from the user's daily routines, sent and received messages, and activity in the client application 130 and other applications. As an additional example, the user interest user parameter 124 can include keywords and other content extracted from events that the user attended. In the latter example, content can be weighted based on the user's level of participation.

The event data 127 can represent information regarding events held by or associated with an organization. Records of upcoming (and past) events can be stored in the event data 127 when that information is received from a client device 106, event server 110, or elsewhere. The event data 127 can include one or more informational tags 128 stored in association with events in the event data 127. The informational tags 128 can include keywords and keyphrases that represent the content of and other information about an event. Informational tags 128 and recordings of events can be received from the tagging service 112 and stored in the event data 127 in association with their corresponding event.

The client device 106 can be representative of a plurality of client devices 106 that can be coupled to the network 115. The client device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 106 or can be connected to the client device 106 through a wired or wireless connection.

The client device 106 can be configured to execute various applications such as a client application or other applications. The client application 130 can be executed in a client device 106 to access network content served up by the computing environment 103 or other servers, thereby rendering a user interface on a display. To this end, the client application 130 can include a browser, a dedicated application, or other executable, and the user interface can include a network page, an application screen, or other user mechanism for obtaining user input. The client device 106 can be configured to execute applications beyond the client application 130 such as email applications, social networking applications, word processors, spreadsheets, or other applications.

The client application 130 can allow a user to join, leave, or otherwise participate in event sessions. The client application 130 can interact with an event server 110 to participate in an event session. In some implementations, the client application 130 can be provided with application programming interfaces (APIs) for various video- or audio-conferencing providers associated with the event servers 110 so that the client application 130 can place API calls that allow the client application 130 to participate in event sessions.

The client application 130 can receive informational tags 128 for various events, including events that the user has attended or will attend, from the tagging service 112. The client application 130 can allow the user to subscribe to one or more of these informational tags 128 so that the user may be recommended events associated with these or similar informational tags 128. The client application 130 can notify the recommendation application 118 that the user has subscribed to one or more informational tags 128.

The client application 130 can provide information that may be relevant to the user's user parameters 124 to the recommendation application 118. The client application 130 can obtain information regarding a user's organizational role, organization unit, location, schedule, and other information from the user or other applications installed on the client device 106. The client application 130 can obtain information regarding a user's interests by prompt the user to complete a questionnaire. The recommendation application 118 can use the results of this questionnaire to gather information about categories and topics in which the user is interested, as well as date and time periods during which the user may be interested in attending events.

The client application 130 can receive recommendations from the recommendation application 118, present them to the user, and receive the user's responses to those recommendations (e.g., accepting or declining). The client application 130 can present these recommendations to the user by, for example, presenting a notification (a push notification or a passive notification), a prompt, or other indication of the recommendation on a user interface in a display of the client device 106. The client application 130 can likewise present a selectable component that allow the user to accept the recommendation and a selectable component that allows the user to decline the recommendation. The client application 130 can then provide to the recommendation application an indication of the user's response to the recommendation, i.e., whether the user accepted or declined the recommendation.

The recording service 109 can obtain recordings of events. In some implementations, the recording service 109 can generate an automated “bot user” to host or join an event session via the event server 110. The recording service 109 can generate a recording of the event and provide the completed recording to the tagging service 112 or stream recorded content to the tagging service 112 during the event session. In some implementations, the recording service 109 can be provided with APIs for various video- or audio-conferencing providers associated with the event servers 110 so that the recording service 109 can place API calls that allow the bot server to participate in event sessions.

The event server(s) 110 can represent server computing devices operated by video- or audio-conferencing providers or other entities capable of facilitating events. An event server 110 can interact with the client application 130, the recording service 109, or other entities to enable creation, management, and participation in event sessions. In some implementations, an event server 110 can provide the client application 130 with an API so that the client application 130 can place API calls to allow the client application 130 to participate in event sessions.

The tagging service 112 can generate informational tags 128 based on content of events. The tagging service 112 can generate informational tags 128 using, for example, pre-event content, event session content, and other information. The tagging service 112 can analyze pre-event content like event invitation and pre-event notes for keywords and key phrases that may correspond to informational tags 128 relevant to an event. To obtain informational tags 128, the tagging service 112 can perform keyword analyses on text associated with pre-event content to identify any keyphrases, including individual words and n-grams. The tagging service 112 can employ one or more machine learning algorithms or other keyphrases extraction approaches such as, for example, EmbedRank, TextRank, TopicRank, KeyBERT, and other approaches.

To analyze event session content, including any recording or other content generated during an event session, the tagging service 112 can perform speech-to-text conversion on any audio components of the event session content. The tagging service 112 can generate an event transcript using this converted text and any other text content generated during the event session. The tagging service 112 can generate informational tags 128 from event session content, including the event transcript, by using one or more machine learning algorithms or other keyphrases extraction approaches. In some implementations, generating informational tags 128 from the event session content can include comparing one or more keyphrases extracted from the event transcript with any keyphrases extracted from the pre-event content.

The tagging service 112 can generate informational tags 128 that can include a combination of keyphrases from the pre-event content and the event session content. In some implementations, keyphrases from the pre-event content and keyphrases from the event session content can be weighted differently.

For context analysis, the tagging service 112 can use natural language processing models for text extraction and keyword analysis. For both text extraction and keyword analysis, transformer-based models can be deployed to the tagging service 112 and trained on text-based data. As newer data is made available to the tagging service 112, these models can be retrained to improve accuracy in text extraction and keyword analysis.

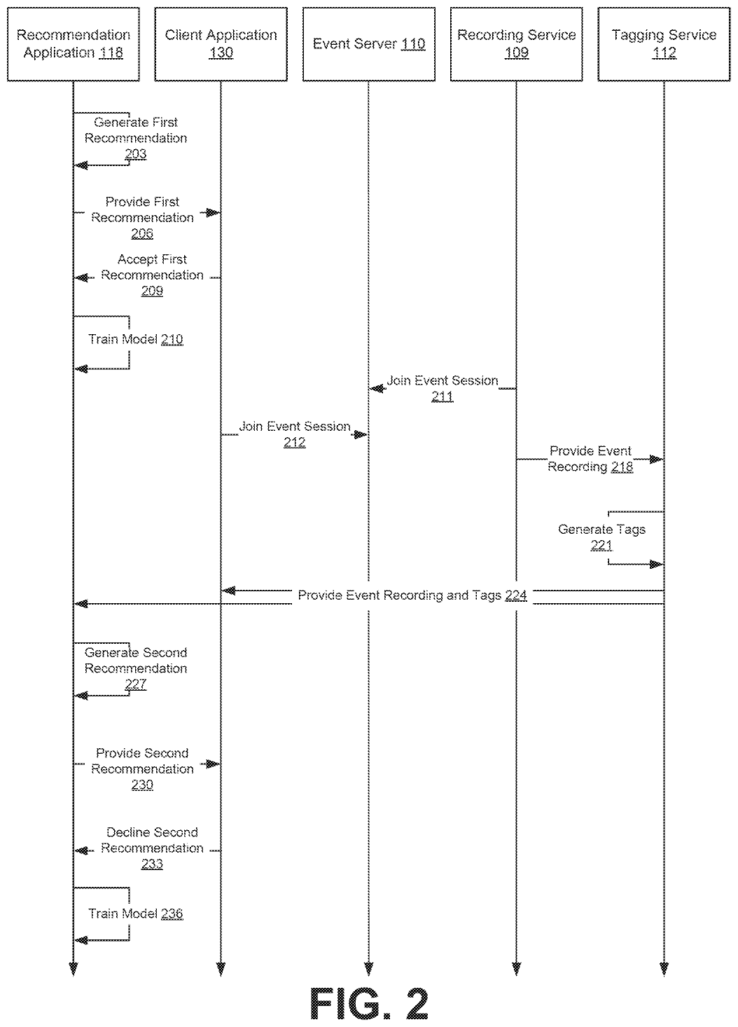

FIG. 2 shows a sequence diagram that provides one example of functionality implemented by components of the networked environment 100. It is understood that the sequence diagram of FIG. 2 provides merely an example of the many different types of functional arrangements that can be employed to implement the portions of the networked environment 100 as described herein. As an alternative, the sequence diagram of FIG. 2 can be viewed as depicting an example of elements of a method implemented within the networked environment 100.

At step 203, the recommendation application 118 can generate a first recommendation of an event for a user of a client application 130 executing on a client device 106. The recommendation application 118 can generate the first recommendation using the reinforcement learning model 122. The reinforcement learning model 122 can have been initialized with randomized recommendations corresponding to the user. Using the reinforcement learning model 122, the recommendation application 118 can then generate the first recommendation based on the user parameters 124. At step 206, the recommendation application 118 can provide the first recommendation to the client application 130.

At step 209, the client application 130 can indicate to the recommendation application 118 that the first recommendation has been accepted. When the client application 130 receives the first recommendation from the recommendation application, the client application 130 can notify the user about the first recommendation. The client application 130 can notify the user by, for example, sending a push or passive notification on the client device 106, displaying a prompt or other indication of the first recommendation in a user interface of the client device 106, or by any other method. The user can interact with a selectable component corresponding to the notification, prompt, or other indication of the first recommendation to accept the first recommendation. The client application 130 can then provide to the recommendation application 118 an indication that the first recommendation has been accepted.

At step 210, the recommendation application 118 can train the reinforcement learning model 122 based on the user's acceptance of the first recommendation. By doing so, the recommendation application 118 can attempt to increase the likelihood that the user will accept future recommendations. For example, the recommendation application 118 can in the future recommend events that are similar to the event corresponding to the first recommendation, based on the informational tags 128 associated with that event.

At step 211, the recording service 109 can interact with the event server 110 to host or join an event session for the recommended event. For example, the recording service 109 can generate an automated “bot user” to host or join the event session via the event server 110. In some implementations, the recording service 109 can be provided with an API corresponding to the event server 110 so that the recording service 109 can place API calls that allow the bot server to participate in event sessions.

At step 212, the client application 130 can interact with the event server 110 to join the event session. The client application 130 can join the event session by connecting to the event server 110. the client application 130 can be provided with an API corresponding to the event server 110 so that the client application 130 can place API calls that allow the client application 130 to participate in event sessions.

At step 218, the recording service 109 can provide a recording of the event session to the tagging service 112. In some implementations, the recording service 109 can generate a recording of the event and provide the completed recording to the tagging service 112. In other implementations, the recording service 109 can stream recorded content from the event session to the tagging service 112 during the event session.

At step 221, the tagging service 112 can generate one or more informational tags 128 for the event. For example, the tagging service 112 can generate the informational tags 128 from the event recording and other content related to the event. If the event recording is in audio form, the machine learning server can perform text-to-speech conversion of the event recording to generate a transcript for the event. Other content used to generate the informational tags 128 can include, for example, pre-event content like an invitation for the event or any pre-event notes for the event. The tagging service 112 can perform keyword analyses on content from the event to identify one or more keyphrases to generate the informational tags 128.

At step 224, the tagging service 112 can provide the recording of the event session and the informational tags 128 to the recommendation application 118 and client application 130. In some implementations, however, informational tags 128 for pre-event content may have been generated and provided to the recommendation application 118 and/or client application 130 previously, before the event was recommended.

At step 227, the recommendation application 118 can generate a second recommendation of an event for the user. The recommendation application 118 can have trained the reinforcement learning model 122 at step 210 based on the user accepting the previous recommendation. The recommendation application 118 can then generate a second recommendation based on the user parameters 124. At step 230, the recommendation application 118 can provide the second recommendation to the client application 130.

At step 233, the client application 130 can indicate to the recommendation application 118 that the second recommendation has been declined. As discussed above, the user can interact with a selectable component corresponding to a notification, prompt, or other indication of the second recommendation to decline the second recommendation. The client application 130 can then provide to the recommendation application 118 an indication that the second recommendation has been declined.

At step 236, the recommendation application 118 can train the reinforcement learning model 122 based on the user declining the second recommendation. By doing so, the recommendation application 118 can attempt to increase the likelihood that the user will accept future recommendations. For example, in the future the recommendation application 118 can recommend events that are less like the event corresponding to the second recommendation, based on the informational tags 128 associated with that event.

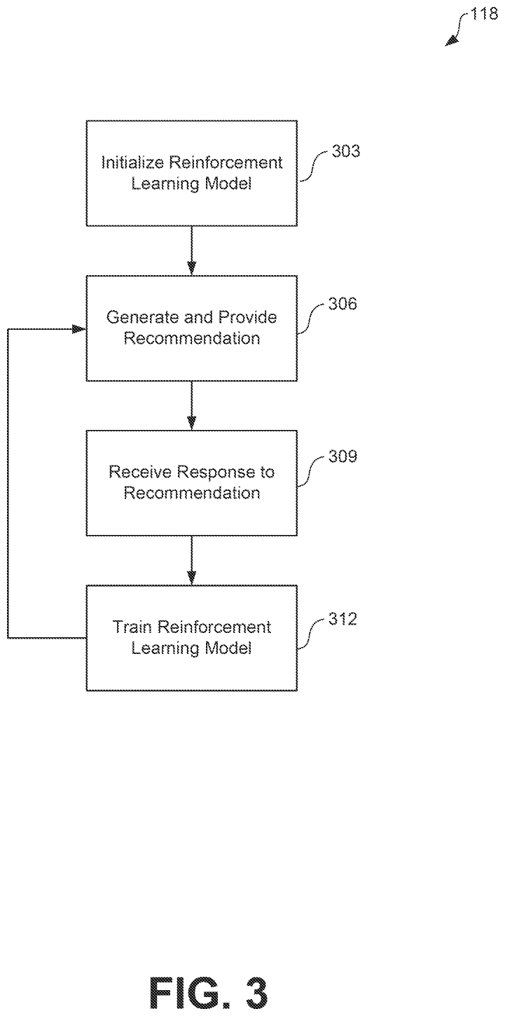

FIG. 3 shows a flowchart that provides one example of the operation of a portion of the recommendation application 118. The flowchart of FIG. 3 provides merely an example of the many different types of functional arrangements that can be employed to implement the operation of the depicted portion of the recommendation application 118. As an alternative, the flowchart of FIG. 3 can be viewed as depicting an example of elements of a method implemented within the networked environment 100.

At step 303, the recommendation application 118 can initialize the reinforcement learning model 122. In some implementations, the reinforcement learning model 122 can be initialized based on one or more randomized recommendations. Using randomized recommendations allows the reinforcement learning model 122 to vary its recommendations for each user.

At step 306, the recommendation application 118 can generate an event recommendation and provide that recommendation to the client device 106. The recommendation application 118 can generate the recommendation using the reinforcement learning model 122. The recommendation can be generated based on one or more of the user parameters 124 associated with a user of the client device 106. For example, the recommendation application 118 can be more likely to recommend an event if that event is associated with informational tags 128 that match or are similar to the user's user parameters 124.

At step 309, the recommendation application 118 can receive a response to the recommendation from the client device 106. The response can indicate that the user has accepted or declined the recommendation.

At step 312, the recommendation application 118 can train the reinforcement learning model 122 based on the response received at step 309. For example, if the response indicates that the user accepted the recommendation, the reinforcement learning model 122 may be more likely to recommend future events with informational tags 128 that are similar to the informational tags 128 stored in association with the event in the event data 127. As another example, if the response indicates that the user declined the recommendation, the reinforcement learning model 122 may be less likely to recommend future events with informational tags 128 that are similar to the informational tags 128 stored in association with the event in the event data 127. The process can then proceed back to step 306.

A phrase, such as “at least one of X, Y, or Z,” unless specifically stated otherwise, is to be understood with the context as used in general to present that an item, term, etc., can be either X, Y, or Z, or any combination thereof (e.g., X, Y, and/or Z). Similarly, “at least one of X, Y, and Z,” unless specifically stated otherwise, is to be understood to present that an item, term, etc., can be either X, Y, and Z, or any combination thereof (e.g., X, Y, and/or Z). Thus, as used herein, such phrases are not generally intended to, and should not, imply that certain embodiments require at least one of either X, Y, or Z to be present, but not, for example, one X and one Y. Further, such phrases should not imply that certain embodiments require each of at least one of X, at least one of Y, and at least one of Z to be present.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present disclosure defined in the following claims, the scope of which are to be accorded the broadest interpretation so as to encompass modifications and equivalent structures.

What is claimed is:

1. A system for recommending events using machine learning, comprising:
at least one computing device comprising a processor and a memory;
machine-readable instructions stored in the memory that, when executed by the processor, cause the at least one computing device to at least:
generate a first recommendation based at least in part on at least one user parameter associated with a user, the first recommendation comprising a first event;
provide the first recommendation to a client device associated with the user;
receive a user response to the first recommendation from the client device;
generate a second recommendation based at least in part on the user response and the at least one user parameter, the second recommendation comprising a second event; and
provide the second recommendation to the client device.

2. The system of claim 1, wherein the machine-readable instructions, when executed by the processor, further cause the at least one computing device to at least:
receive an informational tag associated the first event and a recording of the first event from a tagging service; and
store the informational tag and the recording in association with the first event in a data store accessible to the at least one computing device.

3. The system of claim 1, wherein machine-readable instructions that cause the at least one computing device to generate the first recommendation based at least in part on the at least one user parameter associated with the user further cause the at least one computing device to at least:
provide the at least one user parameter to a reinforcement learning model; and
obtain the first recommendation from the reinforcement learning model.

4. The system of claim 3, wherein the machine-readable instructions, when executed by the processor, further cause the at least one computing device to at least, in response to receiving the user response to the first recommendation, train the reinforcement learning model based at least in part on the user response to the first recommendation.

5. The system of claim 3, wherein the machine-readable instructions, when executed by the processor, further cause the at least one computing device to at least initialize the reinforcement learning model using at least one randomized recommendation.

6. The system of claim 1, wherein the machine-readable instructions, when executed by the processor, further cause the at least one computing device to at least:
receive an indication of a subscribed informational tag from the client device;
identify a third event comprising the subscribed informational tag;
generate a third recommendation comprising the third event; and
provide the third recommendation to the client device.

7. The system of claim 1, wherein the at least one user parameter comprises at least one of an organizational role corresponding to the user, an organizational unit associated with the user, a location associated with the user, a schedule corresponding to the user, or an interest of the user.

8. A method for recommending events using machine learning, comprising:
generating a first recommendation based at least in part on at least one user parameter associated with a user, the recommendation comprising a first event;
providing the first recommendation to a client device associated with the user;
receiving a user response to the first recommendation;
generating a second recommendation based at least in part on the user response and the at least one user parameter, the second recommendation comprising a second event; and
providing the second recommendation to the client device.

9. The method of claim 8, further comprising:
receiving an informational tag associated the first event and a recording of the first event from a tagging service; and
storing the informational tag and the recording in association with the first event in a data store.

10. The method of claim 8, wherein generating the first recommendation based at least in part on the at least one user parameter associated with the user further comprises:
providing the at least one user parameter to a reinforcement learning model; and
obtaining the first recommendation from the at least one reinforcement learning model.

11. The method of claim 10, further comprising in response to receiving the user response to the first recommendation, training the reinforcement learning model based at least in part on the user response to the first recommendation.

12. The method of claim 10, further comprising initializing the reinforcement learning model using at least one randomized recommendation.

13. The method of claim 8, further comprising:
receiving an indication of a subscribed informational tag from the client device;
identifying a third event comprising the subscribed informational tag;
generating a third recommendation comprising the third event; and
providing the third recommendation to the client device.

14. The method of claim 8, wherein the at least one user parameter comprises at least one of an organizational role corresponding to the user, an organizational unit associated with the user, a location associated with the user, a schedule corresponding to the user, or an interest of the user.

15. A non-transitory, computer-readable medium for recommending events using machine learning, comprising machine-readable instructions that, when executed by a processor of at least computing device, cause the processor to at least:
generate a first recommendation based at least in part on at least one user parameter associated with a user, the recommendation comprising a first event;
provide the first recommendation to a client device associated with the user;
receive a user response to the first recommendation from the client device;
generate a second recommendation based at least in part on the user response and the at least one user parameter, the second recommendation comprising a second event; and
provide the second recommendation to the client device.

16. The non-transitory, computer-readable medium of claim 15, wherein the machine-readable instructions, when executed by the processor, further cause the at least one computing device to at least:
receive an informational tag associated the first event and a recording of the first event from a tagging service; and
store the informational tag and the recording in association with the first event in a data store accessible to the at least one computing device.

17. The non-transitory, computer-readable medium of claim 15, wherein machine-readable instructions that cause the at least one computing device to generate the first recommendation based at least in part on the at least one user parameter associated with the user further cause the at least one computing device to at least:
provide the at least one user parameter to a reinforcement learning model; and
obtain the first recommendation from the at least one reinforcement learning model.

18. The non-transitory, computer-readable medium of claim 17, wherein the machine-readable instructions, when executed by the processor, further cause the at least one computing device to at least:
initialize the reinforcement learning model using at least one randomized recommendation; and
in response to receiving the user response to the first recommendation, train the reinforcement learning model based at least in part on the user response to the first recommendation.

19. The non-transitory, computer-readable medium of claim 15, wherein the machine-readable instructions, when executed by the processor, further cause the at least one computing device to at least:
receive an indication of a subscribed informational tag from the client device;
identify a third event comprising the subscribed informational tag;
generate a third recommendation comprising the third event; and
provide the third recommendation to the client device.

20. The non-transitory, computer-readable medium of claim 15, wherein the at least one user parameter comprises at least one of an organizational role corresponding to the user, an organizational unit associated with the user, a location associated with the user, a schedule corresponding to the user, or an interest of the user.
